(19) United States
(12) Patent Application Publication
(10) Pub. No.: US 2025/0317511 A1
(43) Pub. Date: Oct. 9, 2025

(54) SYSTEM AND METHOD FOR IMPROVED AUTOMOTIVE SAFETY

(71) Applicant: JOHN F. LEONARD, Haddonfield, NJ (US)

(72) Inventor: JOHN F. LEONARD, Haddonfield, NJ (US)

(21) Appl. No.: 19/052,926

(22) Filed: Feb. 13, 2025

Related U.S. Application Data
(63) Continuation-in-part of application No. 17/895,698, filed on Aug. 25, 2022, now Pat. No. 12,256,037.
(60) Provisional application No. 63/393,328, filed on Jul. 29, 2022.

(51) Int. Cl. H04M 1/72463; H04M 1/72454; H04W 4/48; H04W 4/80

(52) U.S. Cl. CPC H04M 1/724631; H04M 1/72454; H04W 4/48; H04W 4/80

(57) ABSTRACT

A system and method for improved automotive safety, particularly aimed at the prevention of automobile, truck, and other vehicle accidents related to driving in a distracted manner while using a cell phone.

### CROSS REFERENCE TO RELATED APPLICATION

This application is a continuation-in-part of U.S. application Ser. No. 17/895,698 filed on Aug. 25, 2022 that claimed the benefit of U.S. Provisional Application No. 63/393,328 filed on Jul. 29, 2022.

### FIELD OF THE INVENTION

The general field of the instant invention is technology for the improvement of automotive safety, particularly with respect to the use by drivers distracted by their use of cell phones while driving.

### BACKGROUND OF THE INVENTION

Texting while driving is well known to cause automotive accidents, many of which end in death. For example, it has been reported that 14% of fatal car crashes involve cell phones. In 2018, over 400,000 people were injured and over 2,800 people died in distracted driving motor vehicle accidents. Tellingly, a full 42% of high school students admitted in 2015 that they text or email during driving, and statistics say that cell phone usage reduces a driver's attention by as much as 37%. (as reported by Children's Hospital of Philadelphia Research Institute) For these statistics and other examples, see: https://www.thezebra.com/resources/research/texting-and-driving-statistics/

While law enforcement measures have been implemented in order to stem the crisis of distracted driving, the crisis continues unabated.

### SUMMARY OF THE INVENTION

Presently, the technology available is not sufficient to cure the crisis stated above, much less to prevent individual cases of distracted driving. In addition to the law enforcement efforts stated above, and while some vehicles do not allow the operator to enter navigation requests on the dashboard during driving, the technology as it currently exists does not prevent a driver from distracted driving while using his or her cell phone” vs using the hands free feature. As another example of such limited technology, the program known as Android Auto acts simply to bring apps from a cell phone to the car display so that “you can focus while you drive.” Android promises the driver that “you can control features like navigation, maps, calls, text messages, and music.” Not only is using Android Auto solely a voluntary choice by a driver, but moreover the program requires a potential user to obtain information about that driver's car's compatibility with Android Auto by contacting the vehicle manufacturer. See generally:

https://www.android.com/auto/?gclid=Cj0KCQjwz96WBhC8ARIsAATR253-jtig-jaYbZkRHL4ibFQzbib_cwWQ2HzKe-pHjvPFeeTPI8vSYS0aAl14EALw_wcB&gclsrc=aw.ds

As described herein, the instant invention, once installed, does not provide a driver with a voluntary choice to drive undistracted; rather the instant invention prevents a driver, once installed, from accessing any application programs on a cell phone while driving as described in the preferred embodiment hereinbelow.

### BRIEF DESCRIPTION OF THE DRAWING

FIG. 1 is a flowchart of the application program that enables the method of the preferred embodiment of the present invention.

FIG. 2 is a block diagram of the system of the preferred embodiment of the present invention.

FIG. 3 is a block diagram of the system of an embodiment of the present invention.

### DETAILED DESCRIPTION OF THE INVENTION

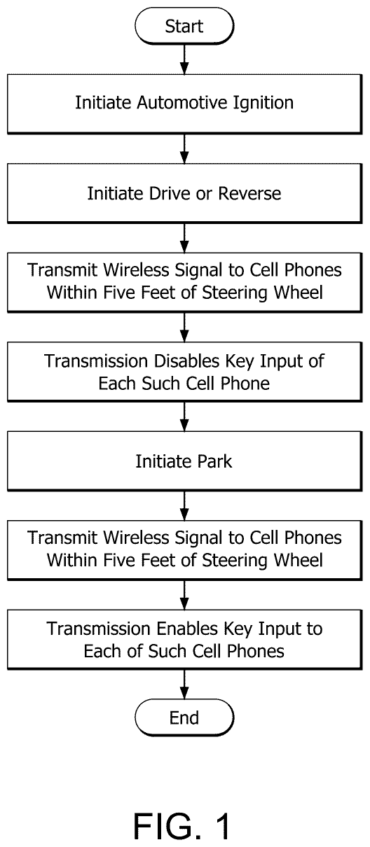

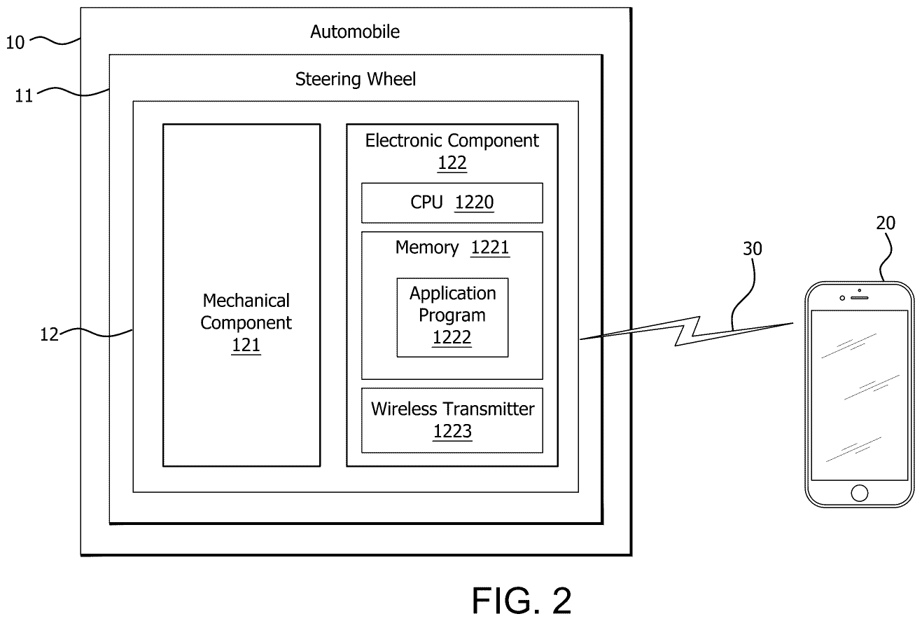

Referring to the drawings filed herewith, the flowchart of FIG. 1 sets forth the steps of the software application program 1222 of the instant invention that is shown in the block diagram of the hardware of the preferred embodiment of the disclosed system. FIG. 2 shows an automobile, truck, or bus 10, having a steering wheel 11 in which is constructed an electromechanical device 12, having a mechanical component 121 that identifies movement of vehicle 10, such as an accelerometer, and an electronic component 122 comprised of a CPU 1220, a wireless receiver/transmitter 1223, and a memory 1221 in which is stored an application program 1222. Additionally, FIG. 2 shows a cell phone 20 located within five feet of steering wheel 11 within said vehicle 10, said cell phone being in communication with said electrical component 122 through wireless connection 30. Said communication 30 can be, for example, a Bluetooth wireless link, but this is not a limitation on the breadth to be afforded this invention.

As per the flowchart of FIG. 1, when a driver starts up his or her vehicle, the mechanical component 121 of electromechanical device 12 senses motion of vehicle 10. Mechanical component 121 is outfitted to send an electronic signal to electronic component 122, which signal triggers CPU 1220 to initiate application program 1222 resident in memory 1221 of said electronic component 122. Said application program 1222 causes CPU 1220 to cause wireless transmitter 1223 to send a disabling signal via wireless link 30 to each cell phone 20 located within 5 feet of said steering wheel 11. As said flowchart shows, once PARK is initiated by the driver of vehicle 10 and mechanical component 121 senses a cessation of movement, an electronic signal is sent from said mechanical component 121 to electronic component 122, causing CPU 1220 in coordination with application program 1222 to send a wireless signal via wireless connection 30 to each cell phone 20 within five feet of steering wheel 11 cancelling the disabling signal that was previously sent to each such cell phone 20, allowing the handheld use of said cell phones 20 once again.

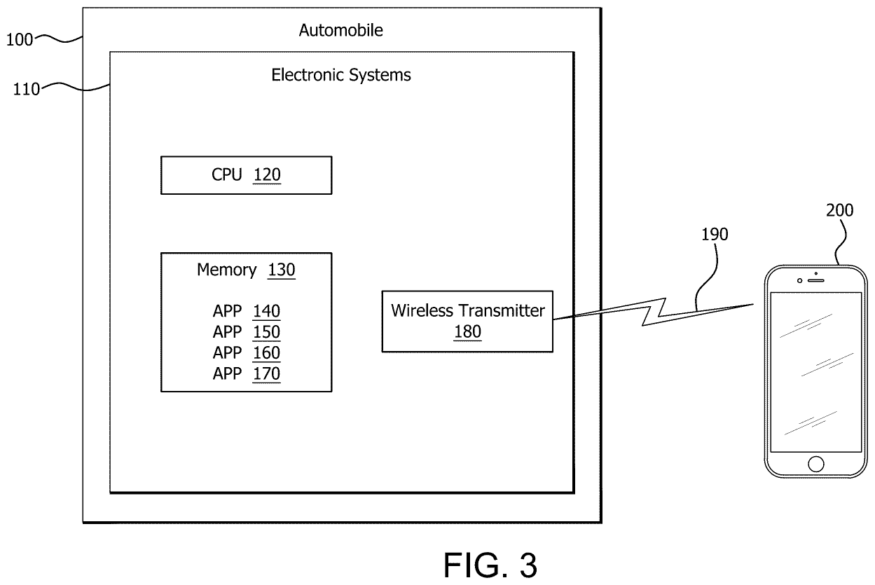

FIG. 3 shows an embodiment of the instant invention. FIG. 2 shows an automobile, truck, or bus 100, having built-in electronic systems 110 that are comprised of a CPU 120, a wireless transmitter 180, and memory 130 in which are stored a panoply of application programs (“apps”), including app 140, app 150, app 160, and app 170, the later being an application designed to prevent distracted driving. FIG. 3 shows a cell phone 200 located within said vehicle 100, said cell phone having stored therein a resident application program compatible with and in communication with said app 170 through wireless connection 190, said application program having control over certain functions of said cell phone 200. Said communication 190 can be, for example, a Bluetooth wireless link, but this is not a limitation on the breadth to be afforded this invention.

In this embodiment of the instant invention after a driver initiates automotive ignition in vehicle 100 and then initiates drive mode or reverse mode of said vehicle 100, app 170 in said vehicle 100 electronic system 110 receives an electronic signal identifying the initiation of one of said modes, which signal is generated by CPU 120 under the control of app 140 stored in memory 130. Said CPU 120 under the control of said app 170 causes wireless transmitter 180 to send a disabling signal via wireless link 190 to said compatible application program resident in cell phone 200. Once the park mode is initiated by said driver of said vehicle 100, an electronic signal identifying such mode initiation causes CPU 120 under the control of app 170 to send a wireless signal via wireless connection 190 to said compatible application program stored in memory of said cell phone 200 cancelling the disabling signal that was previously sent to each such cell phone 200, allowing the handheld use of the key input of said cell phone 200 once again.

App 170 in another embodiment is programmed to generate a disabling signal that is sent by wireless transmitter 180 to a second app in said cell phone 200 that controls the disabling of the screen display of cell phone 200 as well as controlling the disabling of the key input of said cell phone 200. In a third embodiment, app 170 is programmed to generate a disabling signal that is sent by the wireless transmitter 180 to said second app in said cell phone 200 that controls the disabling of the touch screen of said cell phone 200.

What is claimed is:

1. A system for preventing distracted driving of a vehicle having a built-in electronics system by a driver in possession of a cell phone comprising:
a first application program stored in memory of said electronics system;
a wireless transmitter included in said electronics system;
wherein said first application program transmits a wireless signal to said cell phone when said driver places said vehicle in drive mode or reverse mode which signal is compatible with and in communication with a second application program resident in memory of said cell phone and which second application program controls the disabling of certain functionality of said cell phone.

2. The system of claim 1 in which said functionality of said cell phone controlled by said second application program is selected from the group comprising: key input functionality; touch screen functionality; and display screen functionality.

3. The system of claim 1 in which said wireless signal is a Bluetooth signal.

4. An improvement to an automotive electronics system having a built-in wireless transmitter for preventing distracted driving of a vehicle by a driver in possession of a cell phone, said improvement comprising a first application program stored in memory of said electronics system;
wherein said first application program transmits a wireless signal to said cell phone when said driver places said vehicle in drive mode or reverse mode which signal is compatible with and in communication with a second application program resident in memory of said cell phone and which second application program controls the disabling of certain functionality of said cell phone.

5. The improvement of claim 4 in which said functionality of said cell phone controlled by said second application program is selected from the group comprising: key input functionality; touch screen functionality; and display screen functionality.

6. The improvement of claim 4 in which said wireless signal is a Bluetooth signal.

7. A method for preventing distracted driving of a vehicle having a built-in electronics system by a driver in possession of a cell phone comprising the steps of:
initiating ignition of said vehicle,
placing said vehicle into drive mode or the reverse mode;
a first application program resident in memory of said electronics system sensing said mode,
said first application program sending a first signal to a wireless transmitter resident in said electronics system;
said first signal causing said transmitter to transmit a first wireless signal to wireless receiver resident in said cell phone;
said wireless receiver sending a signal to a second application program resident in said cell phone;
said second application program processing said first wireless signal;
said second application controlling the central processing unit of said cell phone by sending a second signal controlling certain functionality of said cell phone;
whereby said driver is unable to use certain functionality of said cell phone.

8. The method of claim 7 wherein said certain functionality of said cell phone controlled by said second application program is selected from the group comprising: key input functionality; touch screen functionality; and display screen functionality.

9. The method of claim 7 in which said wireless signal is a Bluetooth signal.

10. The method of claim 7 further comprising the steps of:
placing said vehicle into park mode,
sensing said mode,
transmitting a second wireless signal to said cell phone,
whereby said certain functionality of said cell phone is restored for use by said driver.

11. The method of claim 10 wherein said certain functionality of said cell phone controlled by said second application program is selected from the group comprising: key input functionality; touch screen functionality; and display screen functionality.

12. The method of claim 11 in which said second wireless signal is a Bluetooth signal.

13. A system for preventing distracted driving of a vehicle by a driver in possession of a cell phone comprising:
a first application program;
a wireless transmitter;
a second application program,
wherein said first application program transmits a wireless signal to said cell phone when said driver places said vehicle in drive mode or reverse mode which signal is compatible with and in communication with said second application program resident in memory of said cell phone and which second application program controls the disabling of certain functionality of said cell phone.

14. An improvement to an automotive electronics system for preventing distracted driving of a vehicle by a driver in possession of a cell phone, said improvement comprising:
a first application program;
a wireless transmitter;
a second application program,
wherein said first application program transmits a wireless signal to said cell phone when said driver places said vehicle in drive mode or reverse mode which signal is compatible with and in communication with said second application program resident in memory of said cell phone and which second application program controls the disabling of certain functionality of said cell phone.
